(19) United States
(12) Patent Application Publication
(10) Pub. No.: US 2015/0135628 A1
(43) Pub. Date: May 21, 2015

(54) SYSTEM AND METHOD OF STONEWORK INSTALLATION

(71) Applicant: Stonehaven Company, LLC, Sartell, MN (US)

(72) Inventor: Thomas L. Schlough, Sartell, MN (US)

(21) Appl. No.: 14/523,213

(22) Filed: Oct. 24, 2014

Related U.S. Application Data
(63) Continuation of application No. 14/034,135, filed on Sep. 23, 2013, now abandoned.
Application No. 14/034,135 is a continuation of application No. 13/410,026, filed on Mar. 1, 2012, now abandoned.
(60) Provisional application No. 61/560,100, filed on Nov. 15, 2011.
(60) Provisional application No. 61/449,391, filed on Mar. 4, 2011.

(51) Int. Cl. E04F 13/08; E04F 13/14; B32B 37/12; E04F 13/09

(52) U.S. Cl. CPC E04F 13/0801; E04F 13/09; E04F 13/144; B32B 37/12
USPC 52/596; 52/747.12; 29/428; 428/78; 156/60

(57) ABSTRACT

A system and method of attaching a natural stone to a wall surface includes attaching a piece of natural stone to a base plate so as to leave at least a portion of the base plate uncovered by the piece of natural stone and attaching the base plate to the wall surface with a fastener extending through the uncovered portion of the base plate.

### CROSS REFERENCE TO RELATED APPLICATIONS

This application is a continuation of U.S. patent application Ser. No. 14/034,135, filed, Sep. 23, 2013, which is a continuation of U.S. patent application Ser. No. 13/410,026, filed Mar. 1, 2012. U.S. patent application Ser. No. 13/410,026 claims the benefit of U.S. Provisional Application No. 61/560,100, filed Nov. 15, 2011, and U.S. Provisional Application No. 61/449,391, filed Mar. 4, 2011. The above-mentioned applications are incorporated herein by reference in their entirety.

### TECHNICAL FIELD

The present disclosure relates generally to systems and methods of stonework installation. More particularly, the present disclosure relates to systems and methods for attaching natural stone veneers to wall surfaces.

### BACKGROUND

A current method for installing thin natural stone veneers requires that the wall surfaces be prepared in advance of installation by attaching metal lath to the wall followed by a “scratch coat” of mortar/grout. After the scratch coat has been applied and is given time to dry, the stone installer applies adhesive mortar to the back of each piece of natural stone veneer to be installed. The installer then places the piece of stone in the appropriate location on the wall and the stone adheres to the scratch coat. This process tends to be slow, messy, and tedious. The appearance and quality of the installation is highly dependent on the skill and artistry of the installer. Each piece is normally hand selected and often shaped to fit into a pattern that is developed by the installer as the installer proceeds.

A major problem associated with the installation of “adhered veneer” is that of adhesion (cracking of the scratch coat or adhesion bond). Adhesion can especially be a problem on larger walls since larger surface areas tend to deflect more due to wind and other loading forces.

Another challenge that is inherent in the conventional installation of natural stone is that the sizes of the pieces of stone are completely random. The pattern for the stonework is normally developed by the installer as the installer proceeds on the jobsite. The design of the pattern for the installation of the stone and the appearance of the wall, therefore, is completely dependent upon the experience and the capabilities of the installer and can be unpredictable. Thus, depending upon the skills, the experience, and the capabilities of a given installer, costs and appearance can vary greatly.

Improved methods of stonework installation, especially in the area of thin natural stone veneer installation, are desired.

### SUMMARY

One aspect of the present disclosure relates to novel methods for attaching natural stone veneers to wall surfaces. More specifically, one example method includes mounting a piece of natural stone to a base plate, wherein the base plate has an outer peripheral dimension that is greater than the outer dimension of the piece of natural stone. After the piece of natural stone is mounted to the base plate, the base plate is attached to a wall surface with fasteners through those portions of the base plate that extend past the periphery of the piece of natural stone. According to an example method, the natural stone veneers can be installed in an overlapping arrangement similar to installation of shingles. The installer can generally start at the lower portion of a wall and move upwardly, with the natural stone portions of the upper veneers overlapping the base plate portions of the lower veneers. This type of an overlapping arrangement can be beneficial with water run-off and limit trapping of water that can otherwise seep into the wall. After installation, the joints between each individual piece of veneer can be caulked or grouted.

According to another aspect of the disclosure, a method of attaching a natural stone to a wall surface is disclosed. The method comprises attaching a first piece of natural stone to a first base plate so as to leave at least a portion of the first base plate uncovered by the first piece of natural stone and attaching the first base plate to the wall surface with a fastener extending through the uncovered portion of the first base plate.

According to yet another aspect of the disclosure, a method of manufacturing a stone veneer configured for attachment to a wall surface is disclosed. The method comprises attaching at least one piece of natural stone to a base plate so as to leave at least a portion of the base plate uncovered by the at least one piece of natural stone.

According to yet another aspect of the disclosure, a natural stone veneer configured for attachment to a wall surface is disclosed. The natural stone veneer comprises a piece of natural stone attached to a base plate so as to leave at least a portion of the base plate uncovered by the piece of natural stone.

According to yet another aspect of the disclosure, a wall comprising natural stone veneers is provided. The wall defines a wall surface. A first piece of natural stone attached to a first base plate so as to leave at least a portion of the first base plate uncovered by the first piece of natural stone is attached to the wall surface with a fastener extending through the uncovered portion of the first base plate. A second piece of natural stone attached to a second base plate so as to leave at least a portion of the second base plate uncovered by the second piece of natural stone is attached to the wall surface so as to overlap the uncovered portion of the first base plate with a portion of the second base plate that is covered by the second piece of natural stone. Both being natural stones, the second piece of natural stone defines a different configuration than the first piece of natural stone such as surface texture. In certain embodiments, the second piece of natural stone defines a different peripheral size than the first piece of natural stone.

According to yet another aspect of the disclosure, a method or process of stonework installation is provided, wherein the method includes designing a pattern of stonework for a given wall and using a guide applied or projected onto the wall that associates the designed pattern with pieces of natural stone veneers to facilitate the installation process. According to one aspect, the pattern may be designed using a computer program. According to another aspect, the pieces of natural stone may be selected and cut in accordance with the designed pattern prior to the installation process, wherein an installer would need to purchase only those pieces of natural stone required to complete the project. According to another aspect, the patterns may be designed using natural stones or natural stone veneers of prescribed standard heights and lengths, wherein the stones or veneers of prescribed standard heights and lengths may be used to create a variety of different looking patterns depending upon how the stones or veneers are arranged on the pattern(s).

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

The accompanying drawings are included to provide a further understanding of the inventive aspects of the present disclosure and are incorporated in and constitute a part of this specification. The drawings illustrate exemplary embodiments of the present disclosure and together with the description serve to further explain the principles of the disclosure. Other aspects of the present disclosure and many of the advantages of the present disclosure will be readily appreciated as the present disclosure becomes better understood by reference to the following Detailed Description when considered in connection with the accompanying drawings, and wherein:

FIG. 1 illustrates a method of stonework installation having features that are examples of inventive aspects in accordance with the principles of the present disclosure;

FIG. 2 illustrates a front view of an example embodiment of a natural stone veneer according to the present disclosure;

FIG. 3 illustrates a front view of another example embodiment of a natural stone veneer according to the present disclosure;

FIG. 4 illustrates a front view of another example embodiment of a natural stone veneer according to the present disclosure;

FIG. 5 illustrates a front perspective view of another example embodiment of a natural stone veneer according to the present disclosure, the stone veneer configured to be used as a corner piece;

FIG. 6 illustrates a cross-section of a portion of a wall with natural stone veneers attached thereto in accordance with the principles of the present disclosure;

FIG. 6A illustrates a close-up view of a portion of the wall of FIG. 6;

FIG. 7 illustrates an example stonework layout including different sizes/shapes of natural stone veneers formed in accordance with the principles of the present disclosure; and

FIG. 8 diagrammatically illustrates an example method of installing stonework on a wall surface in accordance with the principles of the present disclosure.

### DETAILED DESCRIPTION

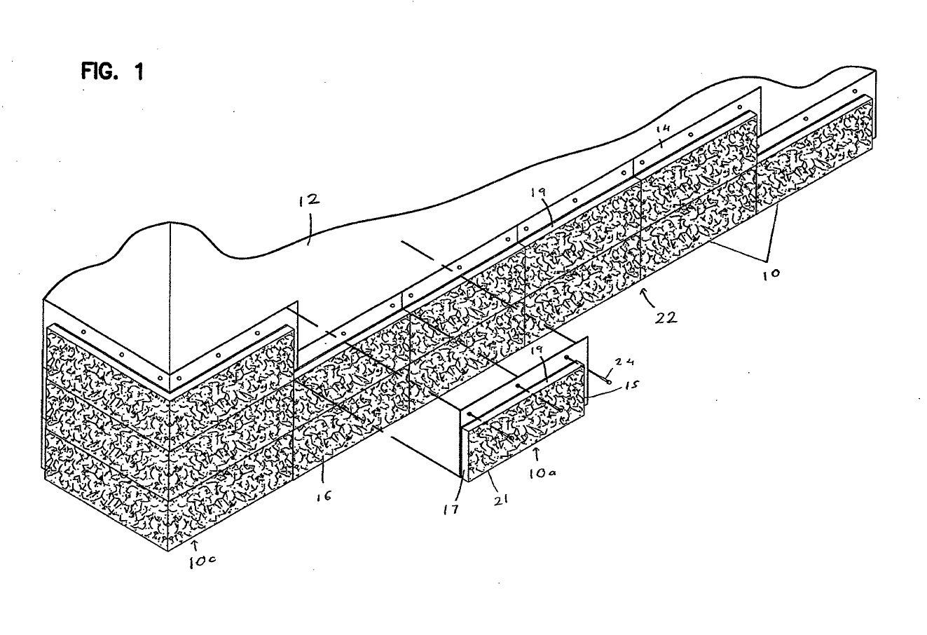

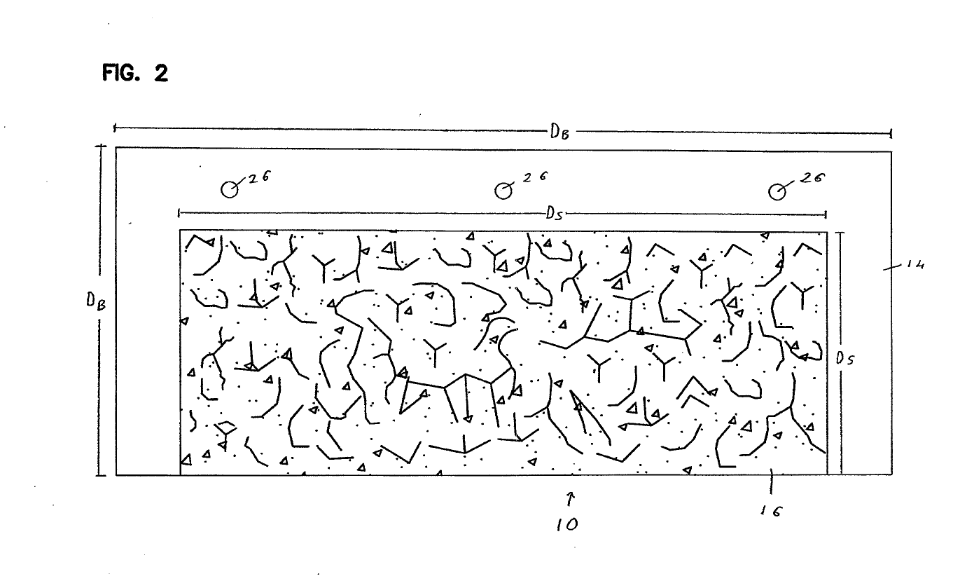

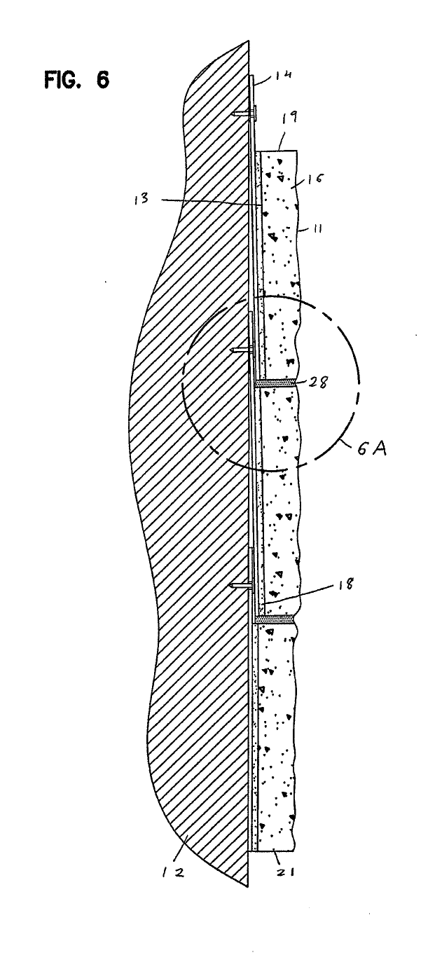

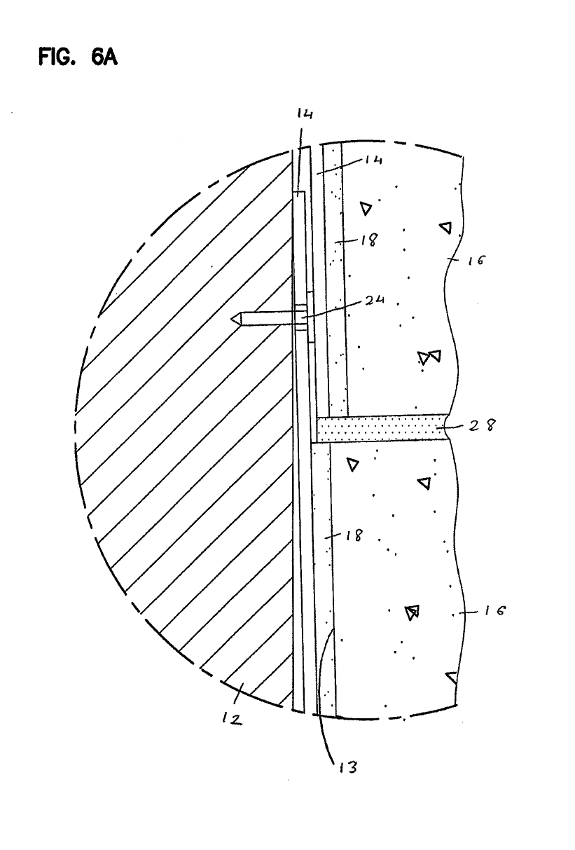

FIGS. 1-8 illustrate a method for attaching natural stone veneers 10 to wall surfaces 12 in accordance with the principles of the present disclosure. One example of a natural stone veneer 10 having features that are examples of inventive aspects in accordance with the present disclosure is shown in FIG. 2. The natural stone veneer 10 includes a base plate or substrate 14. The base plate 14 may be manufactured from various metals, polymers, or composite materials depending upon the desired application. According to the attachment method, a piece of natural stone 16 is mounted to the base plate 14 using an appropriate high performance adhesive or epoxy 18 (shown in FIGS. 6 and 6A). The base plate 14 and the piece of natural stone 16 are sized such that when the natural stone 16 is mounted to the base plate 14, the base plate 14 defines a peripheral dimension D_{B} that is greater than the outer peripheral dimension D_{S} of the piece of natural stone 16. In this manner, the base plate 14 defines portions 20 that extend past the periphery of the piece of natural stone 16 for the purpose of attachment to a wall surface 12.

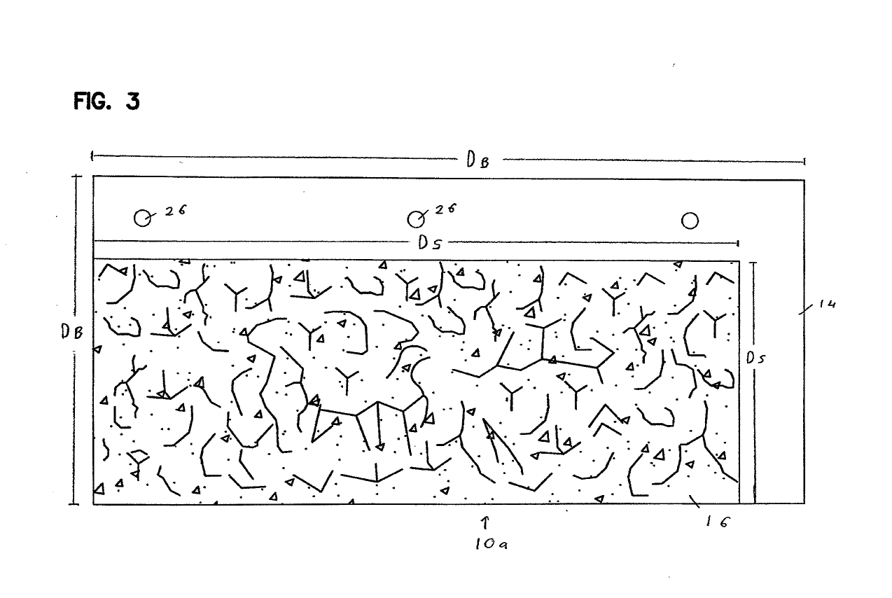

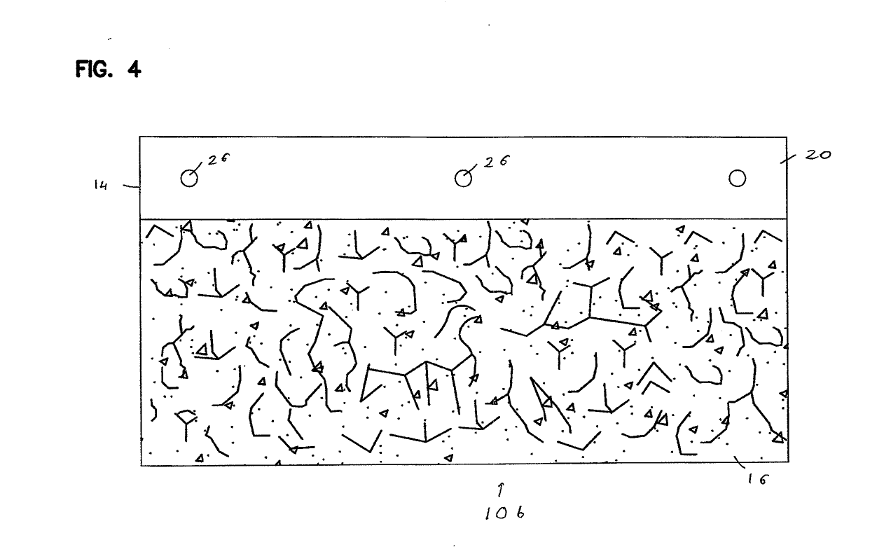

According to one example system and method of the present disclosure, the natural stone veneer 10 shown in FIG. 2 is in non-final form and may require further processing steps before being ready to be mounted to a wall. For example, depending upon where the stone veneer is going to be positioned on a wall and its orientation, one or more portions of the base plate 14 may be trimmed or cut to provide the stone veneer in final form for installation. FIG. 3 illustrates a natural stone veneer 10a that is formed by trimming or cutting a portion of the base plate 14 of the natural stone veneer 10 shown in FIG. 2. FIG. 4 illustrates another example of a natural stone veneer 10b that is formed by trimming or cutting further portions of the base plate of the natural stone veneer 10 shown in FIG. 2. The natural stone veneer that is shown in FIG. 3 is formed by trimming or cutting the portion of the base plate that extends out past the left side of the natural stone. The natural stone veneer 10b that is shown in FIG. 4 is formed by trimming or cutting portions of the base plate 14 that extend out both past the right side and the left side of the natural stone 16.

Providing the natural stone veneer 10 to an installer in the form illustrated in FIG. 2 provides flexibility and cost savings for both the manufacturer of the veneers and the installers. In this manner, a majority of the natural stone veneers may be manufactured and provided in the universal form shown in FIG. 2 and may be trimmed according to the desired application or layout before the installation process.

According to an example method of the present disclosure, the natural stone veneers 10 can be installed in an overlapping arrangement similar to installation of shingles. The installer can generally start at a lower portion of a wall 12 and move upwardly, with the natural stone portion 16 of an adjacent upper veneer 10 overlapping the base plate portion 14 of the lower veneer 10, covering the fasteners 24 of the lower veneer 10. This type of an overlapping arrangement can be beneficial with water run-off and limit trapping of water that can otherwise seep into the wall 12. After installation, the joints between each individual piece of veneer 10 can be sealed with caulk or grout 28. FIG. 6 illustrates a cross-section of a portion of a wall 12 with natural stone veneers 10 attached in an overlapping configuration in accordance with the methods disclosed in the present application. FIG. 6A illustrates a close-up view of the wall 12 of FIG. 6.

When a stone veneer such as the veneer 10a shown in FIG. 3 is used in constructing the stonework pattern, the veneers will also overlap along a side-to-side direction in addition to the up-down direction. It should be noted that the side-to-side direction (e.g., right or left) may also depend upon at which corner the installer initially starts. During installation, natural stone veneers such as the veneer 10a shown in FIG. 3 may be used to cover a majority of the pattern to help with water entrapment and run-off. A natural stone veneer such as the veneer 10b shown in FIG. 4 may be used if there is a transition from leftward oriented pieces to rightward oriented pieces. This might occur, for example, when an installer has reached an opposite corner where there is already a veneer in place with a base plate portion having an extension toward the other installed veneers.

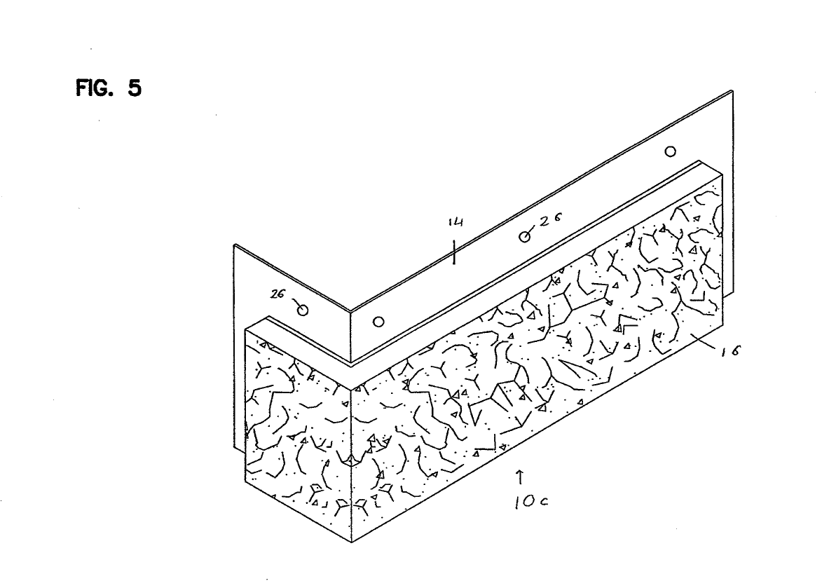

Another embodiment of a natural stone veneer 10c is illustrated in FIG. 5. The natural stone veneer 10c is similar to those shown in FIGS. 2-4 but may be used as a corner piece. Again, depending upon which corner the veneer will be used on and which direction the installation will take place, different portions of the base plate may be trimmed or cut. The corner piece veneer 10c shown in FIG. 5 is in non-final form.

As noted above, depending upon the relative sizes of the base plate 14 and the natural stone 16 and depending upon which portions of the base plate that are cut or trimmed, different types of veneer pieces 10, wherein different portions of the base plate 14 project past the periphery of the natural stone 16, can be provided. As discussed above, FIG. 3 illustrates a front view of a natural stone veneer 10a where the base plate 14 includes portions 20 that extend out above and past the right side of the natural stone 16. Such a veneer 10a may be used as if the overlapping arrangement is in a rightward direction. For an overlapping arrangement that is in the opposite direction, the portions 20 of the base plate 14 that extend past the natural stone 16 can be reversed from that shown in FIG. 3. FIG. 4 illustrates a front view of a natural stone veneer 10b where the base plate 14 includes portions that extend out only above the natural stone 16. As discussed above, such a veneer piece 10b may be used as a transition piece in a stonework layout 22 such as shown in FIG. 1.

According to one non-limiting example, once the natural stone veneer is trimmed to a final form for installation, the base plate 14 may have a width of about 22 inches and a height of about 10 inches. A stone 16 having a width of about 19.5 inches and a height of about 7.5 inches may be positioned on the base plate 14. Since it may be desired to leave about 0.25 inches on all sides of the stone 16 for placement of a sealant, such as grout, between joints, the total wall coverage provided by the stone piece 16 and the grout 28 would be about 8 inches by 20 inches. The remaining 2 inches of base plate 14 extending from, for example, the top and right side of the stone 16 could then be used for mounting the veneer piece 10. The noted sizes simply represent one example embodiment of a natural stone veneer and other sizes can certainly be used according to the desired stonework pattern and application.

According to one example embodiment, the natural stone 16 includes a front face 11 having a texture that is generally rougher than the rear face 13 that is configured to be attached to the base plate 14. According to another example embodiment, the natural stone 16 includes a front face 11, a right face 15, a left face 17, a top face 19, and a bottom face 21 each having a texture that is generally rougher than the rear face 13 that is configured to be attached to the base plate 14.

According to the method of stonework installation of the present application, after a piece of natural stone 16 is mounted to the base plate 14, the base plate 14 may be attached to a wall surface 12 using fasteners 24 such as nails or screws. The portions 20 of the base plates 14 that extend out past the stones 16 may be provided with holes or openings 26 for receiving the fasteners 24. Gaskets may be used with the fasteners 24 for sealing purposes.

The term natural stone is used herein to refer to any non man-made stone occurring naturally in the environment such as granite, marble, etc. As such, no two pieces of natural stone will share exactly the same configuration. Each piece of natural stone might have a different surface texture, appearance, weight, etc. The term non man-made generally excludes those stones, faux stones, or stone substitutes that are non-natural and artificially manufactured such as brick, tile, cement, etc. However, it should be noted that the term non man-made does not exclude processes such as machining, routing, or cutting to provide the natural stone in the desired sizes and shapes. As noted above, the natural stones discussed in the present application may be machined so as to provide a rear face that has a smoother texture than the rest of the faces of the natural stone for attachment to a base plate.

It should also be noted that although the present disclosure discusses the attachment of a single piece of natural stone 16 to a base plate 14, in other embodiments, one or more pieces of natural stone 16 may be attached to a single base plate 14 to form the stone veneer 10.

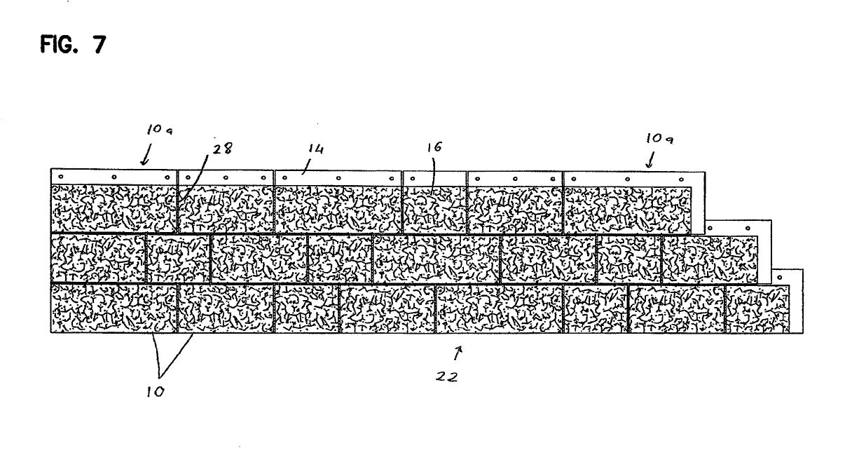

According to one example method of stonework installation, a thin natural stone 16 would be machined by a supplier to fit within predetermined desired stonework pattern or layout 22. Depending upon the pattern 22 desired, different types, different sizes, and different shapes of stones 16 can be used. FIG. 7 illustrates an example stonework layout 22 including different sizes/shapes of natural stone veneers 10 formed in accordance with the principles of the present disclosure. Even if the same types, sizes, and shapes of natural stones are used in the layout, the stonework pattern will still include variances due to the stones being natural stones as noted above.

Each thin stone piece 16 would be fixed, using appropriate high performance adhesive 18, to the base plate 14. The base plate 14 would be provided in a size that accommodates the size of stone 16 being used. As discussed above, once the veneer is manufactured and provided to an installer, different portions of the base plate may be trimmed or cut to make the pieces ready for installation. As such, veneer pieces such as 10a, 10c, or transition piece such as 10b can be produced. The extensions 20 of the base plate 14 are used to mechanically attach the natural stone veneers 10 to the wall surface 12 using fasteners 24 such as gasketed screws or nails. According to the example method, an installer would generally start at the bottom of the wall 12 and move up and also sideways away from the initial veneer 10, with the upper veneers 10 lapping over the lower veneers 10. As noted above, if veneers such as 10a or 10c are used, the veneers would also overlap adjacent veneers along a side-to-side direction. The overlapping configuration may limit water leakage into the wall 12.

The stones 16 and the base plates 14 would be cut to appropriate sizes and shapes for attachment around windows and doors. When the installation of the stone layout 22 is completed, the joints between each individual veneer piece would be caulked or grouted for sealing.

One of the challenges that are inherent in the conventional installation of natural stone is that the sizes of the pieces of stone that an installer has at the jobsite and has available for completing a project are completely random. The pattern for the stonework is normally developed by the installer as the installer proceeds on a given wall. The design of the pattern for the stonework and the appearance of the wall, therefore, are completely dependent upon the experience and the capabilities of the installer, which can lead to varying results.

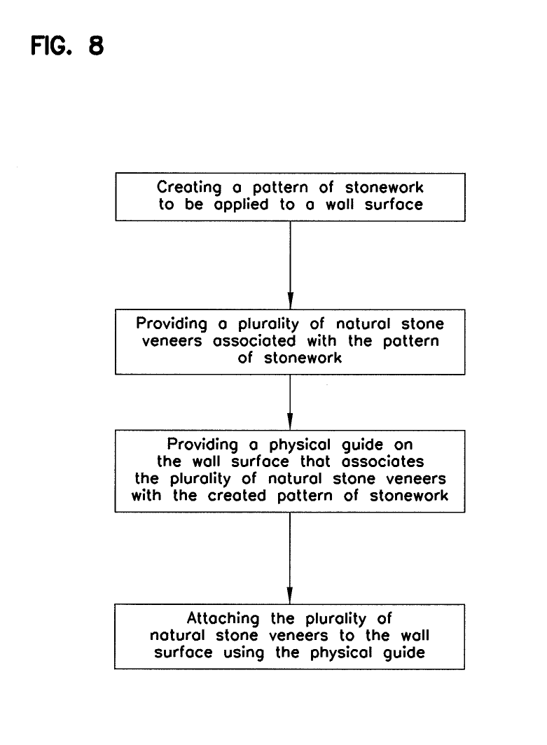

Referring to FIG. 8, an example process of stone installation described below supplements the advantages of the natural stone veneers and the method of installation thereof discussed above to provide for greater control over the look of the stonework and the associated costs for an installation project.

It should be noted that the below described process is simply one example embodiment of a stonework installation process and that other similar processes or those that utilize less than all of the prescribed steps are meant to be covered by the given disclosure.

According to one example embodiment, the dimensions of a given wall for the stonework installation may first be determined. The design of the stonework for the wall using pieces of natural stone in a variety of heights, lengths, types, and colors may be created. According to certain embodiments, the stonework or at least a portion of the stonework may be designed using standard stone heights and/or lengths to reduce the variability of the stones that eventually need to be cut for the project. For example, the natural stones or the natural stone veneers of standard heights and lengths may be used to create a variety of different looking patterns depending upon how the standard stones or veneers are arranged on the patterns.

As noted above, in creating the design of the stonework, a certain pattern for the stone layout or a number of patterns may be created, wherein the patterns, when combined or duplicated, fit the overall stonework design for the wall. The entire stonework design may include a single pattern or a number of different patterns in combination in coming up with the overall look. As noted previously, the pattern or patterns may be created using stones of standard heights and lengths, wherein different looking patterns may be created depending upon how the stones of standard heights and lengths are arranged on the patterns.

In creating the overall stonework design or the individual pattern(s), a computer program or software may be used. The dimension of a given wall or a wall area including the wall length, the wall height, door sizes and locations, window sizes and locations, corner locations may be entered into the program. The pattern(s) or the overall stonework design may be overlaid onto a given wall, taking account all of the given dimensions and features of the wall, such as windows and doors. Or, the pattern(s) or the overall look of the stonework installation can be designed using the computer program or software as the user proceeds.

According to an example embodiment, the computer program or software would have the capability to allow a user to design the pattern(s) as the user proceeds or overlay an already designed pattern onto the image of a given wall. The computer program or software would also have the capability to calculate, based on the pattern(s) being used for the wall, the number of pieces of each size, type, and color of stone needed to complete the project. This process would enable an installer to identify the pieces that must be cut to fit the project pattern as well as the desired dimensions for these pieces and would allow the installer to purchase only the number of pieces of natural stone required to complete the project.

After the stones have been purchased and cut to the desired dimensions, during installation, a physical guide applied or projected onto the wall that associates the designed pattern(s) with the pieces of natural stone veneers to facilitate the installation process may be used, wherein the overall design or the individual pattern(s) could be physically applied to the given wall. According to one example embodiment, the pattern(s) or the design could be printed upon a substrate to be fastened to the wall to be used as a physical guide for the installer. The physical guide may also include a pattern image projected onto the wall surface. The guide may include horizontal grid lines spaced at distances dependent upon the height of the pieces in the pattern(s). The guide may include vertical grid lines spaced at distances dependent upon the increments of length in the pattern(s). Specification of the location of each piece of stone by size, type, and color, wherein the information specified on the grid could be physically recorded on the natural stone veneers, could be used.

In this manner, the advantages of the method of natural stone veneer installation described above are combined with those of the patterning process, wherein the patterning process may include the use of a design program or software and a physical guide that associates the designed pattern(s) with the precut and prepared stone veneer pieces. The combination can improve the efficiency of the installation process and enable an installer to better control the aesthetic results of and the costs associated with the project.

It will be understood that the above described methods of natural stone veneer installation are examples of inventive methods in accordance with the present disclosure. Certain aspects of the methods may be modified depending upon the application.

The above specification provides examples of how certain inventive aspects may be put into practice. It will be appreciated that the inventive aspects can be practiced in other ways than those specifically shown and described herein without departing from the spirit and scope of the inventive aspects.

1. A method of attaching a natural stone to a wall surface, the method comprising:
attaching a first piece of natural stone to a first base plate so as to leave at least a portion of the first base plate uncovered by the first piece of natural stone;
attaching the first base plate to the wall surface with a fastener extending through the uncovered portion of the first base plate.

2. A method according to claim 1, further comprising attaching a second piece of natural stone to a second base plate so as to leave at least a portion of the second base plate uncovered by the second piece of natural stone and attaching the second base plate to the wall surface so as to overlap the uncovered portion of the first base plate with a portion of the second base plate that is covered by the second piece of natural stone.

3. A method according to claim 2, further comprising providing a sealant between the first piece of natural stone and the second piece of natural stone once the pieces of natural stone have been attached to the wall surface.

4. A method according to claim 3, wherein the sealant includes grout.

5. A method according to claim 2, wherein the second piece of natural stone defines a different configuration than the first piece of natural stone.

6. A method according to claim 3, wherein the second piece of natural stone defines a different peripheral size than the first piece of natural stone.

7. A method according to claim 1, further comprising providing at least one fastener hole through the uncovered portion of the first base plate.

8. A method according to claim 1, further comprising attaching the first piece of natural stone to the first base plate with an adhesive.

9. A method according to claim 1, wherein the first base plate includes a metallic material.

10. A method according to claim 1, wherein the first piece of natural stone defines a top end, a bottom end, a right end, and a left end, wherein the first base plate defines uncovered portions that extend out away from at least one of the ends of the first piece of natural stone.

11. A method according to claim 10, wherein the first base plate defines uncovered portions that extend out away from at least two of the ends of the first piece of natural stone.

12. A method according to claim 11, wherein the at least two of the ends of the first piece of natural stone includes one of the top end and the bottom end and one of the right end and the left end.

13. A method according to claim 1, wherein the first base plate defines a greater overall outer peripheral dimension than that of the first piece of natural stone.

14. A method according to claim 1, further comprising attaching a second piece of natural stone to the first base plate so as to leave at least a portion of the first base plate uncovered by the second piece of natural stone.

15. A method of manufacturing a stone veneer configured for attachment to a wall surface, the method comprising:
attaching at least one piece of natural stone to a base plate so as to leave at least a portion of the base plate uncovered by the at least one piece of natural stone.

16. A method according to claim 15, further comprising attaching a second piece of natural stone to the base plate so as to leave at least a portion of the base plate uncovered by the second piece of natural stone.

17. A method according to claim 15, further comprising providing at least one fastener hole through the uncovered portion of the base plate.

18. A method according to claim 15, further comprising attaching the at least one piece of natural stone to the base plate with an adhesive.

19. A method according to claim 15, wherein the base plate includes a metallic material.

20. A method according to claim 15, wherein the at least one piece of natural stone defines a top end, a bottom end, a right end, and a left end, wherein the base plate defines uncovered portions that extend out away from at least one of the ends of the at least one piece of natural stone.

21. A method according to claim 20, wherein the base plate defines uncovered portions that extend out away from at least two of the ends of the at least one piece of natural stone.

22. A method according to claim 21, wherein the at least two of the ends of the at least one piece of natural stone include one of the top end and the bottom end and one of the right end and the left end.

23. A method according to claim 15, wherein the base plate defines a greater overall outer peripheral dimension than that of the at least one piece of natural stone.

24. A natural stone veneer comprising:
a piece of natural stone attached to a base plate so as to leave at least a portion of the base plate uncovered by the piece of natural stone.

25. A natural stone according to claim 24, further comprising a second piece of natural stone attached to the base plate so as to leave at least a portion of the base plate uncovered by the second piece of natural stone.

26. A natural stone veneer according to claim 24, wherein the piece of natural stone is attached to the base plate with an adhesive.

27. A natural stone veneer according to claim 24, further comprising a fastener hole through the uncovered portion of the base plate.

28. A natural stone veneer according to claim 24, wherein the base plate includes a metallic material.

29. A natural stone veneer according to claim 24, wherein the piece of natural stone defines a top end, a bottom end, a right end, and a left end, wherein the base plate defines uncovered portions that extend out away from at least one of the ends of the piece of natural stone.

30. A natural stone veneer according to claim 29, wherein the base plate defines uncovered portions that extend out away from at least two of the ends of the piece of natural stone.

31. A natural stone veneer according to claim 30, wherein the at least two of the ends of the piece of natural stone include one of the top end and the bottom end and one of the right end and the left end.

32. A natural stone veneer according to claim 24, wherein the base plate defines a greater overall outer peripheral dimension than that of the piece of natural stone.

33. A wall comprising:
a wall surface;
a first piece of natural stone attached to a first base plate so as to leave at least a portion of the first base plate uncovered by the first piece of natural stone, wherein the first base plate is attached to the wall surface with a fastener extending through the uncovered portion of the first base plate; and
a second piece of natural stone attached to a second base plate so as to leave at least a portion of the second base plate uncovered by the second piece of natural stone, wherein the second base plate is attached to the wall surface so as to overlap the uncovered portion of the first base plate with a portion of the second base plate that is covered by the second piece of natural stone, the second piece of natural stone defining a different configuration than the first piece of natural stone.

34. A wall according to claim 33, wherein the second piece of natural stone defines a different peripheral size than the first piece of natural stone.

35. A wall according to claim 33, wherein at least one of the first base plate and the second base plate includes at least one fastener hole through the uncovered portion of the base plate.

36. A wall according to claim 33, wherein at least one of the first piece of natural stone and the second piece of natural stone is attached to the corresponding base plate with an adhesive.

37. A wall according to claim 33, wherein at least one of the first base plate and the second base plate includes a metallic material.

38. A method of installing stonework on a wall surface, the method comprising:
creating a pattern of stonework to be applied to a wall surface;
providing a plurality of natural stone veneers associated with the pattern of stonework;
providing a physical guide on the wall surface that associates the plurality of natural stone veneers with the created pattern of stonework; and
attaching the plurality of natural stone veneers to the wall surface using the physical guide.

39. A method according to claim 38, wherein the pattern of stonework to be applied to the wall surface is created using computer software.

40. A method according to claim 38, wherein the guide defines horizontal and vertical grid lines defining installment locations for each of the plurality of natural stone veneers.

41. A method according to claim 38, wherein the guide includes a substrate to be fastened to the wall surface.

42. A method according to claim 38, wherein the guide is a projected pattern image.

43. A method according to claim 38, wherein each of the natural stone veneers includes a piece of natural stone attached to a base plate so as to leave at least a portion of the base plate uncovered by the piece of natural stone.

44. A method according to claim 43, wherein each of the natural stone veneers is attached to the wall surface via a fastener through the portion of the base plate uncovered by the piece of natural stone.
